(19) United States
(12) Patent Application Publication
(10) Pub. No.: US 2025/0201267 A1
(43) Pub. Date: Jun. 19, 2025

(54) METHOD AND APPARATUS FOR EMOTION RECOGNITION IN REAL-TIME BASED ON MULTIMODAL

(71) Applicant: SK TELECOM CO., LTD., Seoul (KR)

(72) Inventors: Chang Hyun KIM, Seoul (KR); Hyejin KOO, Seoul (KR); Sang Hoon LEE, Seoul (KR); Seung Hyeon LEE, Gyeonggi-do (KR)

(21) Appl. No.: 18/836,567

(22) PCT Filed: Jan. 20, 2023
(86) PCT No.: PCT/KR2023/001005

§ 371 Date: Aug. 7, 2024

(30) Foreign Application Priority Data
Feb. 28, 2022 (KR) 10-2022-0025988

(51) Int. Cl. G10L 25/63; G10L 15/02; G10L 15/26

(52) U.S. Cl. CPC G10L 25/63; G10L 15/02; G10L 15/26

(57) ABSTRACT

At least one aspect of the present disclosure provides an emotion recognition method using an audio stream performed by an emotion recognition apparatus including receiving an audio signal having a preset unit length to generate the audio stream corresponding to the audio signal; converting the audio stream into a text stream corresponding to the audio stream; and inputting the audio stream and the converted text stream to a pre-trained emotion recognition model to output a multi-modal emotion corresponding to the audio signal.

### TECHNICAL FIELD

The present disclosure relates to a method and an apparatus for real-time emotion recognition based on a multi-modal. More specifically, the present disclosure relates to a method and an apparatus belonging to the field of non-contact sentiment analysis based on audio-text.

### BACKGROUND ART

The content to be described hereinafter simply provides only background information related to embodiments of the present disclosure and does not constitute the related art.

In the related art, there is a multi-modal sentiment analysis technology for analyzing human emotions. A face recognition-based multi-modal emotion recognition technology of the related art uses an image including a face as main information. The face recognition-based multi-modal emotion recognition technology of the related art uses a voice input as additional information to improve the accuracy of recognition. However, the face recognition-based emotion recognition technology may infringe personal information in data collection. In addition, there is a problem that the face recognition-based emotion recognition technology of the related art does not provide a method of recognizing emotions based on audio and text.

In the related art, there is a multi-modal sentiment analysis technology based on English audio and English text. An English-based multi-modal sentiment analysis technology of the related art recognizes emotions by using an acoustic feature and a word embedding vector in parallel. Here, the acoustic feature includes a scheme for extracting a feature based on an input signal divided into predetermined section units or a Mel Frequency Cepstral Coefficient (MFCC) which is a feature extracted by using the scheme. The word embedding vector may be an embedding vector extracted by using word2Vec, which is a vectorization method for expressing a degree of similarity between words in a sentence. However, an English-based multi-modal sentiment analysis model has not been commercialized due to a performance issue.

In order to improve the performance of a convolutional neural networks (CNN) or long short-term memory (LSTM) based multi-modal sentiment analysis model of the related art, a transformer network using self-attention has been studied. However, a transformer network-based deep learning model of the related art has a problem in that a commercialized model for implementing real-time services cannot be provided due to latency in data processing.

Therefore, there is a need for a method and an apparatus for multi-modal emotion recognition based on audio and text for recognizing emotions in real time.

### DETAILED DESCRIPTION OF INVENTION

### Technical Problems

According to an aspect of the present disclosure, a main object is to provide an emotion recognition apparatus including a cross-modal transformer-based multi-modal transformer model, and an emotion recognition method using the same.

According to another aspect of the present disclosure, another main object is to provide an emotion recognition apparatus including a multi-modal transformer model based on parameter sharing and an emotion recognition method using the same.

### Technical Solution

At least one aspect of the present disclosure provides an emotion recognition method using an audio stream performed by an emotion recognition apparatus including receiving an audio signal having a preset unit length to generate the audio stream corresponding to the audio signal: converting the audio stream into a text stream corresponding to the audio stream; and inputting the audio stream and the converted text stream to a pre-trained emotion recognition model to output a multi-modal emotion corresponding to the audio signal.

Another aspect of the present disclosure provides an emotion recognition apparatus using an audio stream including an audio buffer configured to receive an audio signal with a preset unit length and generate the audio stream corresponding to the audio signal: a speech-to-text (STT) model configured to convert the audio stream into a text stream corresponding to the audio stream; and an emotion recognition model configured to receive the audio stream and the converted text stream and output a multi-modal emotion corresponding to the audio signal.

### Effect of Invention

According to an embodiment of the present disclosure, it is possible to recognize emotions in real time based on audio and text, and to provide the recognized emotions to a user in a non-contact manner.

According to another embodiment of the present disclosure, there is an effect that it is possible to acquire correlation information between modalities without a cross-modal transformer using parameter sharing.

### BRIEF DESCRIPTION OF THE DRAWING

FIGS. 1A and 1B are block diagrams illustrating a configuration of an emotion recognition apparatus according to an embodiment of the present disclosure.

FIG. 2 is a block diagram illustrating a configuration of an emotion recognition model included in the emotion recognition apparatus according to the embodiment of the present disclosure.

FIG. 3 is a block diagram illustrating that the emotion recognition model extracts multi-modal features according to the embodiment of the present disclosure.

FIG. 4 is a block diagram illustrating a configuration of a emotion recognition model included in an emotion recognition apparatus according to another embodiment of the present disclosure.

FIG. 5 is a block diagram illustrating that the emotion recognition model extracts multi-modal features according to the other embodiment of the present disclosure.

FIG. 6 is a flowchart illustrating an emotion recognition method according to an embodiment of the present disclosure.

FIG. 7 is a flowchart illustrating a process of outputting a multi-modal emotion, which is included in the emotion recognition method according to the embodiment of the present disclosure.

FIG. 8 is a flowchart illustrating a process of outputting a multi-modal emotion, which is included in an emotion recognition method according to another embodiment of the present disclosure.

### BEST MODE FOR CARRYING OUT THE INVENTION

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The present disclosure provides a multi-modal based real time emotion recognition method and an emotion recognition apparatus. Specifically, the present disclosure provides an emotion recognition method and an emotion recognition apparatus that can recognize human emotions in real time by inputting speech and text into a pre-trained deep learning model to extract multi-modal features.

The following detailed description, together with the accompanying drawings, is intended to describe exemplary embodiments of the present disclosure and is not intended to represent the only embodiments in which the present disclosure may be practiced.

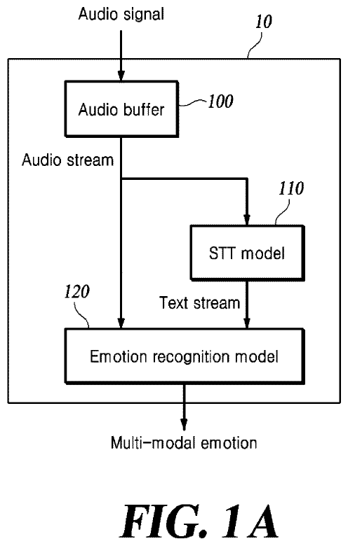

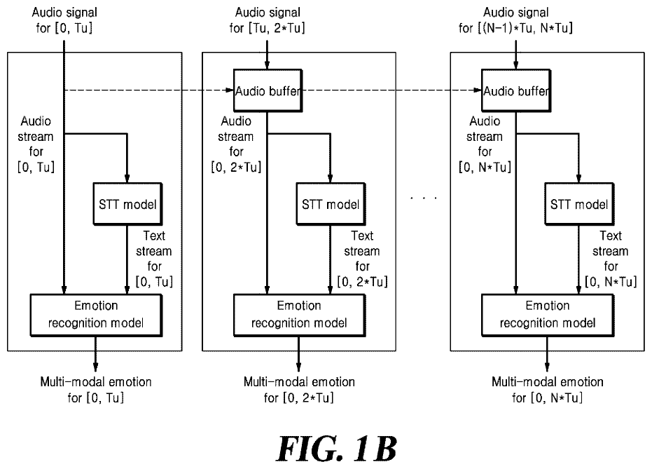

FIGS. 1A and 1B are block diagrams illustrating a configuration of an emotion recognition apparatus according to an embodiment of the present disclosure.

Referring to FIG. 1A, the emotion recognition apparatus according to the embodiment of the present disclosure includes all or some of an audio buffer 100, a speech-to-text model (an STT model) 110, and an emotion recognition model 120. The emotion recognition apparatus 10 shown in FIG. 1a is according to an embodiment of the present disclosure, all blocks shown in FIG. 1a are not essential components, and some blocks included in the emotion recognition apparatus 10 may be added, changed, or deleted in other embodiments.

Hereinafter, respective components included in the emotion recognition apparatus 10 will be described with reference to FIG. 1A.

The audio buffer 100 receives an audio signal having a preset unit length to generate an audio stream corresponding to the audio signal. Specifically, the audio buffer 100 concatenates a pre-stored audio signal with a currently input audio signal to generate an audio stream corresponding to the currently input audio signal. Here, the unit length of the audio signal may be a length of the audio signal corresponding to a preset time section. The entire audio signal may be divided into a plurality of time frames having a unit length and input so that context information is ascertained. A time section for distinguishing between frames may be variously changed according to an embodiment of the present disclosure. Each time an audio signal in a frame unit is input, the audio buffer 100 concatenates the currently input audio signal with the audio signal stored in the audio buffer 100 to generate the audio stream. Accordingly, the audio buffer 100 allows the emotion recognition apparatus 10 to recognize an emotion for each audio stream and ascertain the context information.

The STT model 110 converts the audio stream generated by the audio buffer 100 into the text stream corresponding to the audio stream. When the STT model 110 is not included in the emotion recognition apparatus 10, the audio stream that is only one type of signal is input to the emotion recognition model 120. Accordingly, the STT model 110 allows two types of signals to be input to the emotion recognition model 120 for extracting multi-modal features based on audio and text. Meanwhile, since a method in which the STT model 110 learns using voice learning data in order to output the text stream corresponding to an audio stream, and a specific method in which a pre-trained STT model 110 receives an audio stream and deduces the text stream are common in a relevant technical field, further description thereof will be omitted.

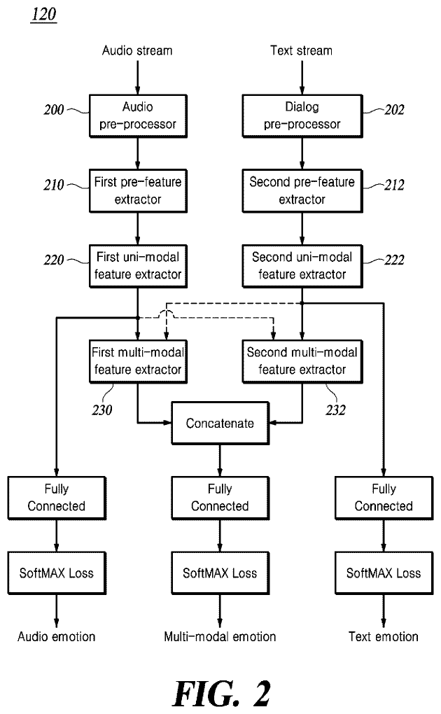

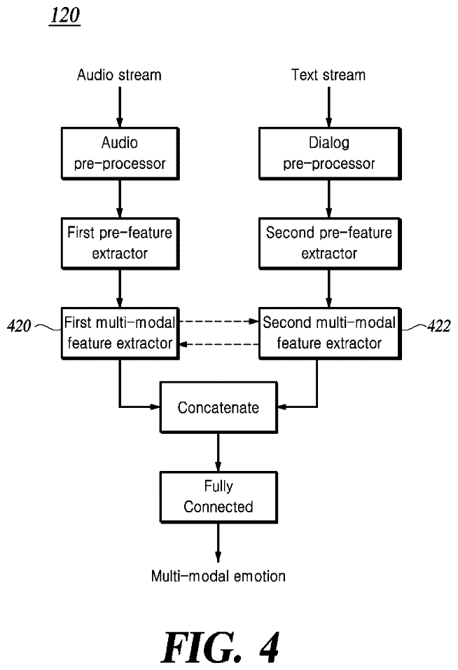

The emotion recognition model 120 receives the audio stream and the converted text stream and outputs a multi-modal emotion corresponding to the audio signal. The emotion recognition model 120 may be a deep learning model pre-trained to output the multi-modal emotion based on the input audio and text information. Accordingly, the emotion recognition model 120 according to the embodiment of the present disclosure may extract a multi-modal feature in which the voice and the text are correlated with each other, based on the voice and the text, and recognize an emotion corresponding to the audio signal from the multi-modal feature. Each component included in the emotion recognition model 120 will be described later with reference to FIGS. 2 and 4.

Referring to FIG. 1B, an embodiment in which the emotion recognition apparatus 10 outputs a multi-modal emotion corresponding to each audio signal from a plurality of audio signals divided in units of frames according to time is illustrated. The emotion recognition apparatus 10 receives a plurality of audio signals corresponding to respective time sections distinguished by a unit length Tu from time 0 to time N*Tu, generates an audio stream corresponding to each audio signal, and outputs a multi-modal emotion corresponding to the generated audio stream. Since the emotion recognition apparatus 10 generates the audio stream using the audio signal accumulated in the audio buffer 100, each multi-modal emotion may include different context information. The audio buffer 100 performs a reset when a length of the audio signal stored in the audio buffer 100 exceeds a preset reference length. For example, the reference length that is a reference of the reset in the audio buffer 100 may be 4 seconds, and the unit length Tu for distinguishing the audio signals may be 0.5 seconds. The emotion recognition apparatus 10 generates the audio stream and the text stream for a section [0, 0.5] from the audio signal for the section [0, 0.5], and outputs a multi-modal emotion for the section [0, 0.5] using the audio stream and the text stream. At the same time, the emotion recognition apparatus 10 concatenates an audio signal for the section [0, 1] and the audio signal for the section [0, 0.5] stored in the audio buffer 100 to generate an audio stream for the section [0, 1]. The emotion recognition apparatus 10 converts the audio stream for the section [0, 1] into a text stream for the section [0, 1], and outputs a multi-modal emotion for the section [0, 1] using the audio stream and the text stream. The emotion recognition apparatus 10 performs an operation of outputting a multi-modal emotion corresponding to the audio stream for each section of 0.5 seconds from the section [0, 0.5] to a section [3.5, 4.0] eight times. In one embodiment, a multi-modal emotion corresponding to the audio stream of a section [0, 2] output by the emotion recognition apparatus 10 may be positive, whereas a multi-modal emotion corresponding to the audio stream of a section [0, 4] output by the emotion recognition apparatus 10 may be negative. That is, since the emotion recognition apparatus 10 repeats an operation of outputting the multi-modal emotion corresponding to the audio stream in which audio signals in a plurality of sections are concatenated, it is possible to ascertain context information of the entire audio signal. Here, since a reference length of the audio buffer 100 is 4 seconds, the audio buffer 100 is reset when the length of the audio signal stored in the audio buffer 100 exceeds 4 seconds. Since the emotion recognition apparatus 10 outputs the multi-modal emotion for each section, a delay due to calculation time buffering may occur. However, since the audio buffer 100 is reset when the length of the audio signal stored in the audio buffer 100 exceeds the reference length, the emotion recognition apparatus 10 can provide, in real time, a multi-modal emotion for a section [0, N*Tu] output based on an audio signal of a last section [(N−1)*Tu, N*Tu]. Meanwhile, in another embodiment of the present disclosure, the unit length Tu for distinguishing between the audio signals may be 1 second. Here, the emotion recognition apparatus 10 performs an operation of outputting a multi-modal emotion corresponding to the audio stream four times for each section having a length of 1 second from a section [0, 1] to a section [3, 4]. That is, the unit length Tu for distinguishing between the audio signals may be variously changed in order to secure real time of the emotion recognition according to a computing environment in which the emotion recognition apparatus 10 operates.

FIG. 2 is a block diagram illustrating a configuration of the emotion recognition model included in the emotion recognition apparatus according to the embodiment of the present disclosure.

Referring to FIG. 2, the emotion recognition model 120 according to the embodiment of the present disclosure includes all or some of an audio pre-processor 200, a first pre-feature extractor 210, a first uni-modal feature extractor 220, the first multi-modal feature extractor 230, a dialog pre-processor 202, a second pre-feature extractor 212, a second uni-modal feature extractor 222, and a second multi-modal feature extractor 232. The emotion recognition model 120 shown in FIG. 2 is according to an embodiment of the present disclosure, and not all blocks shown in FIG. 2 are essential components, and in other embodiments, some of blocks included in the emotion recognition model 120 may be added, changed, or deleted.

The audio pre-processor 200 processes the audio stream into data suitable for processing in a neural network. For example, the audio pre-processor 200 may perform amplitude normalization using resampling to minimize an influence of an environment in which the audio stream is input. Here, the sampling rate may be 16 kHz, but the sampling rate may be variously changed according to an embodiment of the present disclosure, but is not limited thereto. The audio pre-processor 200 extracts a spectrogram corresponding to the normalized audio stream using Short-Time Fourier Transform (STFT). Here, a Fast Fourier Transform window length (FFT window length) and a hop length (hop_length) may be 1024 samples and 256 samples, respectively, but a specific window length and hop length are not limited to the present embodiment.

The dialog pre-processor 202 processes the text stream into data suitable for processing in the neural network. The dialog pre-processor 202 may perform a text normalization task before performing a tokenization task. For example, the dialog pre-processor 202 may extract only English uppercase letters, English lowercase letters, Korean syllables, Korean consonants, numbers, and preset punctuation marks by pre-processing the text stream. The dialog pre-processor 202 may perform pre-processing by converting a plurality of spaces between word segments in a sentence or Korean vowels in the sentence into one space. The dialog pre-processor 202 may perform the tokenization task to extract a plurality of tokens from the normalized text stream. Here, the dialog pre-processor 202 may use a morphology analysis-based model or a subword segmentation-based model as a tokenizer. Here, when the subword segmentation-based model is used, there is an effect that real time can be secured. The dialog pre-processor 202 converts the plurality of extracted tokens into a plurality of indexes corresponding to the tokens in order to generate input data for pre-trained bidirectional encoder representations from transformers (BERT). Since a specific method of performing a tokenization operation using text data is known in the art, further description will be omitted.

The first pre-feature extractor 210 extracts a first feature from the pre-processed audio stream. In an embodiment, the first feature may be an MFCC. The first pre-feature extractor 210 converts the extracted spectrogram into a Mel-scale unit to extract a Mel-spectrogram in order to simulate a perceptual characteristic of a human cochlea. The first pre-feature extractor 210 calculates Mel-Frequency Cepstral Coefficients (MFCCs) from the Mel spectrogram using a septum analysis. Here, the number of calculated coefficients may be 40, but the number of output MFCCs is not limited thereto. Since a more specific method of calculating the MFCC from audio data is known in the art, further description thereof will be omitted. In another embodiment, the first feature may be a Problem-Agnostic Speech Encoder+ (PASE+) feature, which is a feature having performance above the MFCC in an emotion recognition task. Since the PASE+ feature is a learnable feature unlike the MFCC, it is possible to improve the performance of the emotion recognition task. The first pre-feature extractor 210 may use PASE+ which is a pre-trained encoder to output the PASE+ feature. The first pre-feature extractor 210 adds a speech noise (speech distortion) to the pre-processed audio stream and extracts a PASE+ feature from the PASE+. The first feature extracted by the first pre-feature extractor 210 is input to a convolutional layer of the first uni-modal feature extractor 220. PASE+ includes a sync net, a plurality of convolutional layers, a quasi-recurrent neural network (QNN), a linear transformation, and a batch normalization (BN) layer. Meanwhile, the PASE+ feature may be learned using a plurality of workers extracting a specific acoustic feature. Each worker restores the acoustic feature corresponding to the worker from the audio data encoded by the PASE+. When the learning of the PASE+ feature ends, the plurality of workers are removed. Since a learning method for the PASE+ and input and output of layers included in the PASE+ are known in the art, further description thereof will be omitted.

The second pre-feature extractor 212 extracts a second feature from the pre-processed text stream. The second pre-feature extractor 212 may include a pre-trained BERT to extract a feature of a word order included in an input sentence from a context having a long length. That is, the second feature is a feature including information on a context of the text stream. The BERT is a type of Masked Language Model (MLM), which is a model for predicting masked words in an input sentence, based on a context of neighboring words. An input of the BERT includes a sum of position embedding, token embedding, and segment embedding. The BERT inputs an input masked token to a transformer encoder configured of a plurality of transformer modules, and predicts an original unmasked token. Here, the number of transformer modules included in the transformer encoder may be 12 or 24, but a specific structure of the transformer encoder is not limited to the present embodiment. That is, since BERT is a bidirectional language model that considers both a token before the masked token and a token after the masked token in a sentence, it is possible to accurately ascertain the context. The second feature extracted by the second pre-feature extractor 212 is input to a convolutional layer of the second uni-modal feature extractor 222.

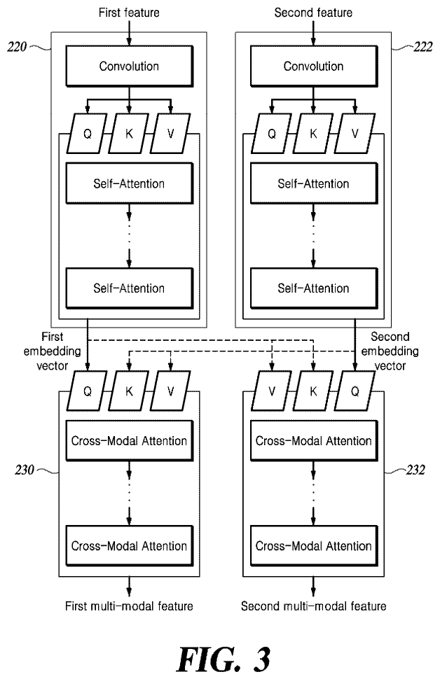

FIG. 3 is a block diagram illustrating that the emotion recognition model extracts the multi-modal features according to an embodiment of the present disclosure.

Referring to FIG. 3, structures of the first uni-modal feature extractor 220, the first multi-modal feature extractor 230, the second uni-modal feature extractor 222, and the second multi-modal feature extractor 232 included in the emotion recognition model 120 are illustrated. The first uni-modal feature extractor 220 receives the first feature and extracts the first embedding vector. The second uni-modal feature extractor 222 receives the second feature and extracts a second embedding vector. Each uni-modal feature extractor may extract an embedding vector from which correlation information within a sentence can be more accurately ascertained, unlike a case where only the feature extracted by the pre-feature extractor is used. Since an utterance or a sentence is sequential data, analysis of temporal information is important. That is, in various sentences in which the same word is combined with other words, emotions of a sentence speaker or a sentence writer may be determined differently according to a context. For example, in a sentence ‘Smile will make you happy.’, the word ‘happy forms a context with the phrase ‘smile’ to express a positive emotion. On the other hand, in a sentence ‘You′d rather be happy if you give up.’, ‘happy’ forms a context with the word ‘give up’ to express a negative emotion. Therefore, the first and second uni-modal feature extractors use a plurality of self-attention layers to acquire temporal and regional correlation information between the words in the sentence. In one embodiment, the number of self-attention layers used by the first and second uni-modal feature extractors may be two, but the specific number of self-attention layers is not limited to the present embodiment. The first multi-modal feature extractor 230 extracts the first multi-modal feature, based on the first embedding vector and the second embedding vector. The second multi-modal feature extractor 232 extracts the second multi-modal feature, based on the second embedding vector and the first embedding vector. That is, each multi-modal feature extractor to correlating heterogeneous embedding vectors to extract a multi-modal feature. Since the emotion recognition model 120 of the present embodiment extracts the multi-modal feature using a cross transformer network, there is an effect that it is possible to perform emotion recognition with high accuracy in consideration of both audio and text.

The first uni-modal feature extractor 220 includes a convolutional layer and a plurality of first self-attention layers. In one embodiment, the first uni-modal feature extractor 220 is connected to BERT for extracting an optimal text feature and can extract an optimal embedding vector for the text. In order for the first multi-modal feature extractor 230 to generate a query embedding vector, a key embedding vector, or a value embedding vector based on the first embedding vector, a dimension of the first feature must be converted. In one embodiment, when the emotion recognition model 120 uses the MFCC or PASE+ as the first feature, the dimension of the first feature may be (40, 256), but a specific number of dimensions of the acoustic feature is not limited to the present embodiment. The first uni-modal feature extractor 220 may change the dimension of the first feature to a preset dimension using a single 1-dimension (1-D) convolutional layer. For example, the converted dimensions may be 40 dimensions. Specifically, the first uni-modal feature extractor 220 passes the first feature through a first convolutional layer and outputs an input vector sequence of the first self-attention layer. An input vector sequence with the preset dimension output from the first convolutional layer may be referred to as a third feature. The first uni-modal feature extractor 220 multiplies the input vector sequence by a weighted matrix for each of a query, a key, and a value. Each weighted matrix is updated and preset in a learning process. Through a matrix operation, a query vector sequence, a key vector sequence, and a value vector sequence are generated from one input vector sequence. The first uni-modal feature extractor 220 inputs the query vector sequence, the key vector sequence, and the value vector sequence to the plurality of first self-attention layers and extracts the first embedding vector. The first embedding vector includes the correlation information between the words in the sentence corresponding to the audio stream. Since a specific calculation process used in a self-attention scheme is known in the art, further description thereof will be omitted.

The second uni-modal feature extractor 222 includes a convolutional layer and a plurality of second self-attention layers. In one embodiment, the second uni-modal feature extractor 222 is connected to PASE+ for extracting an optimal acoustic feature, and can extract an optimal embedding vector for the audio. In order for the second multi-modal feature extractor 232 to generate a query embedding vector, a key embedding vector, or a value embedding vector based on the second embedding vector, a dimension of the second feature must be converted. In one embodiment, when the second pre-feature extractor uses BERT to extract the second feature, the dimension of the second feature may be 768 dimensions, but a specific number of dimensions of the second feature is not limited to the present embodiment. The second uni-modal feature extractor 222 may change the dimension of the second feature to a preset dimension using a single 1-dimension (1-D) convolutional layer. For example, the converted dimension may be 40 dimensions. Specifically, the second uni-modal feature extractor 222 passes the second feature through a second convolutional layer and outputs an input vector sequence of the self-attention layer. An input vector sequence with a preset dimension output from the second convolutional layer may be referred to as a fourth feature. The second uni-modal feature extractor 222 multiplies the input vector sequence by each weighted matrix for the query, key, and value. Each weighted matrix is updated and preset in the learning process. A query vector sequence, a key vector sequence, and a value vector sequence are generated from one input vector sequence through a matrix operation. The second uni-modal feature extractor 222 inputs the query vector sequence, key vector sequence, and value vector sequence to the plurality of second self-attention layers and extracts the second embedding vector. The second embedding vector includes the correlation information between the words in the sentence corresponding to the text stream.

The emotion recognition model 120 uses a cross-modal transformer for extracting correlation information between heterogeneous modality embedding vectors, in order to acquire correlation information between the first embedding vector and the second embedding vector. The cross-modal transformer includes a plurality of cross-modal attention layers. In the present embodiment, the number of heads of multi-head attention may be set to 8, but the present disclosure is not limited thereto. Sentences uttered by humans may include meanings of both compliment and sarcasm even when the sentences are formally the same sentence. In order for the emotion recognition model 120 to determine an actual meaning contained in the sentence, the emotion recognition model 120 must be able to analyze correlation information between the first embedding vector for the voice and the second embedding vector for the text. Therefore, the emotion recognition model 120 uses a pre-trained cross-modal transformer to extract the first multi-modal feature and the second multi-modal feature including correlation information between the voice and the text.

The first multi-modal feature extractor 230 inputs the query embedding vector generated based on the first embedding vector to a first cross-modal transformer, and inputs the key embedding vector and the value embedding vector generated based on the second embedding vector to extract the first multi-modal feature. Since a specific calculation process used in an attention scheme is known in the art, further description thereof will be omitted.

The second multi-modal feature extractor 232 inputs a query embedding vector generated based on the second embedding vector to a second cross-modal transformer, and inputs the key embedding vector and the value embedding vector generated based on the first embedding vector to extract the second multi-modal feature.

Referring to FIG. 2, an output of the first multi-modal feature extractor 230 and an output of the second multi-modal feature extractor 232 are concatenated in a channel direction. That is, the emotion recognition model 120 may concatenate the first multi-modal feature with the second multi-modal feature and recognize emotions from heterogeneous modalities. The emotion recognition model 120 passes the concatenated multi-modal features through a fully connected (FC) layer, inputs an output of the fully connected layer to a SoftMAX function, and estimates a probability of an emotion corresponding to a first input voice signal being included in each emotion class. The emotion recognition model 120 uses a multi-modal classifier to output an emotion label with a highest probability as recognized emotion.

Meanwhile, the emotion recognition model 120 according to the present embodiment further includes an audio emotion classifier that outputs an audio emotion corresponding to the audio stream based on the first embedding vector, and a text emotion classifier that outputs a text emotion corresponding to the text stream based on the second embedding vector. Referring to FIG. 2, outputs of the first and uni-modal feature extractors may be transferred to an independent fully connected layer in addition to the first and second multi-modal feature extractors. The audio emotion classifier and the text emotion classifier can operate as auxiliary classifiers of the multi-modal classifier, to improve the recognition accuracy of the emotion recognition model 120. For example, the text emotion classifier may recognize positive emotion based on a meaning of compliment extracted from a sentence “Good for you.” On the other hand, when the utterance of the same sentence includes a sarcastic intonation, the speech emotion classifier can recognize negative emotions from the input voice. Equation 1 is an equation for obtaining a loss E_{audio} or Eₜₑₓₜ when cross entropy is used as a loss function.

$${E}_{audio ( or text )} = - {\sum }_{k} {t}_{k} ln ( {y}_{k} ) \qquad [ Equation 1 ]$$

yₖ: Estimate for a kth sample of the neural network
tₖ: Value of a ground-truth label for the kth sample
k: Sample index

tₖ is the value of the ground-truth label, and only elements of a ground-truth class have a value of 1, and elements of other classes all have a value of 0. Therefore, when the speech emotion classifier and the text emotion classifier recognize emotions of different labels from the same sentence, a sum of a loss of speech modality and a loss of text modality becomes equal to a sum of natural logarithms of estimates for different classes. That is, since a cross entropy value of each modality reflects an output value when the emotions of different labels are recognized, there is an effect that it is possible to perform accurate emotion recognition for various linguistic expressions.

A multi-modal classifier may perform more accurate emotion recognition based on weight learning using E_{audio} or Eₜₑₓₜ loss calculated according to Equation 1. A total cross-entropy loss reflecting the output of the audio emotion classifier and the text emotion classifier can be expressed as in Equation 2. A weight w_{audio} for a loss of the audio emotion classifier and a weight wₜₑₓₜ for a loss of the text emotion classifier can be updated according to learning.

$${E}_{total} = {E}_{multi - modal} + {w}_{audio} {E}_{audio} + {w}_{text} {E}_{text} = - \{ {\sum }_{k} {t}_{{k}_{multi - modal}} ln ( {y}_{{k}_{multi - modal}} ) - {w}_{audio} {\sum }_{k} {t}_{{k}_{audio}} ln ( {y}_{{k}_{audio}} ) - {w}_{text} {\sum }_{k} {t}_{{k}_{text}} ln ( {y}_{{k}_{text}} ) \} \qquad [ Equation 2 ]$$

yₖ: Estimate for a kth sample of the neural network
tₖ: Value of the ground-truth label for the kth sample
k: Sample index

FIG. 4 is a block diagram illustrating a configuration of an emotion recognition model included in an emotion recognition apparatus according to another embodiment of the present disclosure.

Referring to FIG. 4, the emotion recognition model 120 according to the embodiment of the present disclosure includes all or some of an audio pre-processor, a first pre-feature extractor, a first multi-modal feature extractor 420, a dialogue pre-processor, a second pre-feature extractor, and a second multi-modal feature extractor 422. The emotion recognition model 120 shown in FIG. 4 is according to an embodiment of the present disclosure, all blocks shown in FIG. 4 are not essential components, and some blocks included in the emotion recognition model 120 may be added, changed, or deleted in other embodiments.

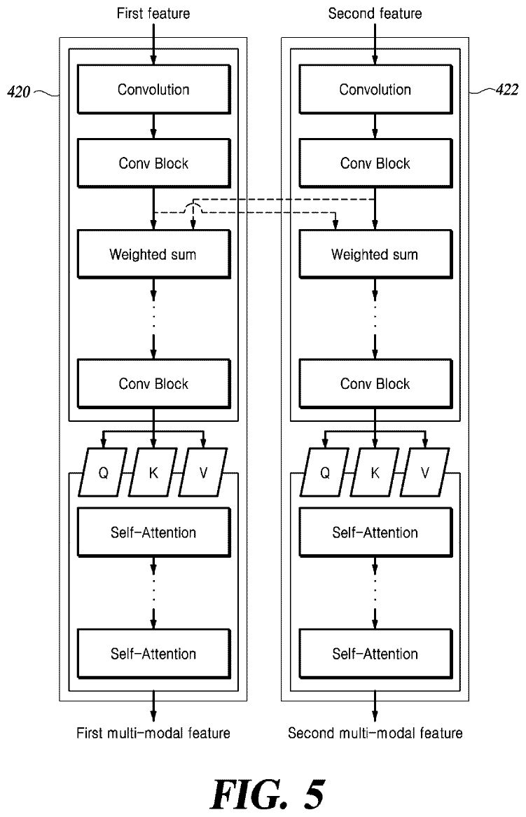

FIG. 5 is a block diagram illustrating extraction of a multi-modal feature in the emotion recognition model according to the other embodiment of the present disclosure.

The emotion recognition model 120 according to the other embodiment of the present disclosure has a network structure based on parameter sharing. The emotion recognition model 120 acquires first and second embedding vectors including correlation information between the audio stream and the text stream, based on a weighted sum of the feature for the audio stream and the feature for the text stream.

Hereinafter, each configuration of the emotion recognition model 120 included in the emotion recognition apparatus according to the other embodiment of the present disclosure will be described with reference to FIGS. 4 and 5. Description of the same configuration as that of the emotion recognition model 120 according to the embodiment of FIGS. 2 and 3 will be omitted.

The first pre-feature extractor included in the emotion recognition model 120 extracts the first feature from the pre-processed audio stream. Here, the first feature may be an MFCC or PASE+ feature. The second pre-feature extractor extracts the second feature from the pre-processed text stream. Here, the second feature may be a text feature extracted using the BERT.

Each of the first multi-modal feature extractor 420 and the second multi-modal feature extractor 422 includes a 1-D convolutional layer, a plurality of convolutional blocks, and a plurality of self-attention layers. The emotion recognition model 120 according to the present embodiment learns weights of heterogeneous modalities using parameter sharing before self-attention. Accordingly, there is an effect that the emotion recognition model 120 can acquire the weight and correlation information between the heterogeneous modalities without the cross-modal transformer.

The first multi-modal feature extractor 420 inputs the first feature extracted by the first pre-feature extractor to the 1-D convolutional layer and maps the dimension of the first feature to a preset dimension. The second multi-modal feature extractor 422 inputs the second feature extracted by the second pre-feature extractor to the 1-D convolutional layer and maps the dimension of the second feature to a preset dimension. Here, the converted dimensions of the first and second features may be 40 dimensions, but a specific value are not limited to the present embodiment. The first and second multi-modal feature extractors 420 and 422 may generate the query embedding vector, the key embedding vector, and the value embedding vector by matching dimensions of outputs of the convolutional blocks.

The first multi-modal feature extractor 420 passes the first feature of which the dimension has been converted through the plurality of convolutional blocks to perform parameter sharing with the second multi-modal feature extractor 422. The second multi-modal feature extractor 422 passes the second feature of which the dimension has been converted through the plurality of convolutional blocks to perform parameter sharing with the first multi-modal feature extractor 420. Each of the convolutional blocks included in the first multi-modal feature extractor 420 and the second multi-modal feature extractor 422 includes a 2-D convolutional layer and a 2-D average pooling layer. Here, the number of convolutional blocks included in each multi-modal feature extractor is 4, and output channels of each convolutional block may be 64, 128, 256, and 512 according to an order of the blocks. However, the number of convolutional blocks and the number of output feature maps may be variously changed according to an embodiment of the present disclosure. The first multi-modal feature extractor 420 performs the parameter sharing with the second multi-modal feature extractor 422 by calculating a weighted sum of the first feature and the second feature each time The first multi-modal feature extractor 420 passes the first feature of which the dimension has been converted through one convolutional block. The second multi-modal feature extractor 422 performs the parameter sharing with the first multi-modal feature extractor 420 by calculating a weighted sum of the second feature and the first feature each time the second multi-modal feature extractor 422 passes the second feature of which the dimension has been converted through one convolutional block. For example, the first multi-modal feature extractor 420 inputs a weighted sum calculated in a first convolution block to a second convolution block. The weighted sum calculated in the first convolution block of the second multi-modal feature extractor 422 is input to the second convolution block. The first multi-modal feature extractor 420 calculates a weighted sum of outputs of the first convolutional blocks in the second convolution block. Here, weights by which the first feature and the second feature are multiplied in each convolution block are learnable parameters. The weights used for the parameter sharing may be adjusted by learning so that accurate correlation information between the heterogeneous modalities is output. The first multi-modal feature extractor 420 outputs the first embedding vector including the correlation information between the audio stream and the text stream by calculating a weighted sum in the last convolutional block. The second multi-modal feature extractor 422 outputs the second embedding vector including correlation information between the text stream and the audio stream by calculating a weighted sum in the last convolutional block.

The first multi-modal feature extractor 420 inputs the query embedding vector, the key embedding vector, and the value embedding vector obtained by multiplying the first embedding vector by the respective weight matrices to the plurality of self-attention layers to extract the first multi-modal feature including temporal correlation information. The second multi-modal feature extractor 422 inputs the query embedding vector, the key embedding vector, and the value embedding vector obtained by multiplying the second embedding vector by the respective weight matrices to the plurality of self-attention layers to extract a second multi-modal feature including temporal correlation information. Here, the number of plurality of self-attention layers included in the first and second multi-modal feature extractors 420 and 422 may be two, but are not limited to the present embodiment.

The emotion recognition model 120 concatenates the first multi-modal feature with the second multi-modal feature on a channel axis, and recognizes an emotion based on the concatenated multi-modal features.

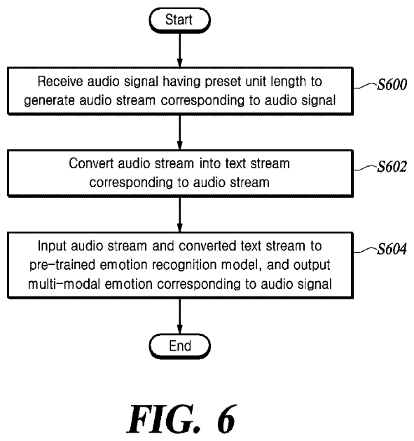

FIG. 6 is a flowchart illustrating an emotion recognition method according to an embodiment of the present disclosure.

The emotion recognition apparatus 10 receive an audio signal having a preset unit length to generate an audio stream corresponding to the audio signal (S600). Here, the emotion recognition apparatus 10 concatenates the audio signal pre-stored in the audio buffer with an input audio signal to generate the audio stream. Meanwhile, the emotion recognition apparatus 10 may reset the audio buffer when the length of the audio signal stored in the audio buffer exceeds the preset reference length.

The emotion recognition apparatus 10 converts the audio stream into the text stream corresponding to the audio stream (S602).

The emotion recognition apparatus 10 inputs the audio stream and the converted text stream to the pre-trained emotion recognition model, and outputs a multi-modal emotion corresponding to the audio signal (S604).

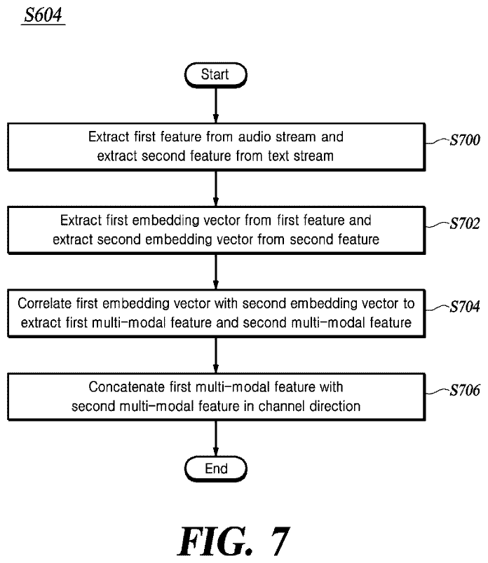

FIG. 7 is a flowchart illustrating a process of outputting a multi-modal emotion included in the emotion recognition method according to the embodiment of the present disclosure.

The emotion recognition apparatus 10 performs a pre-feature extraction process of extracting the first feature from the audio stream and extracting the second feature from the text stream (S700). Here, the pre-feature extraction process may include a process of pre-processing the audio stream or the text stream, and the audio stream or the text stream may be pre-processed data. Here, when the emotion recognition apparatus 10 extracts the first feature, the emotion recognition apparatus 10 may input the audio stream to PASE+ and extract the first feature.

The emotion recognition apparatus 10 performs a uni-modal feature extraction process of extracting the first embedding vector from the first feature and extracting the second embedding vector from the second feature (S702). Here, the uni-modal feature extraction process S702 may include a process of inputting the first feature to the first convolutional layer to extract the third feature having the preset dimension, a process of inputting the third feature to the first self-attention layer to acquire the first embedding vector including the correlation information between the words in the sentence corresponding to the audio stream, a process of inputting the second feature to the second convolutional layer to extract the fourth feature having a preset dimension, and a process of inputting the fourth feature to the second self-attention layer to acquire the second embedding vector including the correlation information between the words in the sentence corresponding to the text stream. Meanwhile, after the emotion recognition apparatus 10 performs the uni-modal feature extraction process S702, the emotion recognition apparatus 10 may perform a process of outputting the audio emotion corresponding to the audio stream based on the first embedding vector. After the emotion recognition apparatus 10 performs the uni-modal feature extraction process (S702), the emotion recognition apparatus 10 may perform a process of outputting a text emotion corresponding to the text stream based on the second embedding vector. That is, the emotion recognition method according to the embodiment of the present disclosure performs an auxiliary classification process of correlating the audio with the text at the same level and classifying audio emotions or text emotions. Further, the emotion recognition method may use a weight of the audio emotion or the text emotion as a control parameter for emotion recognition accuracy.

The emotion recognition apparatus 10 performs a multi-modal feature extraction process of correlating the first embedding vector with the second embedding vector to extract the first multi-modal feature and the second multi-modal feature (S704). Here, the multi-modal feature extraction process includes a process of inputting the query embedding vector generated based on the first embedding vector to the first cross-modal transformer and inputting the key embedding vector and the value embedding vector generated based on the second embedding vector to extract the first multi-modal feature, and a process of inputting the query embedding vector generated based on the second embedding vector to the second cross-modal transformer and inputting the key embedding vector and the value embedding vector generated based on the first embedding vector to extract the second multi-modal feature.

The emotion recognition apparatus 10 concatenates the first multi-modal feature with the second multi-modal feature in the channel direction (S706).

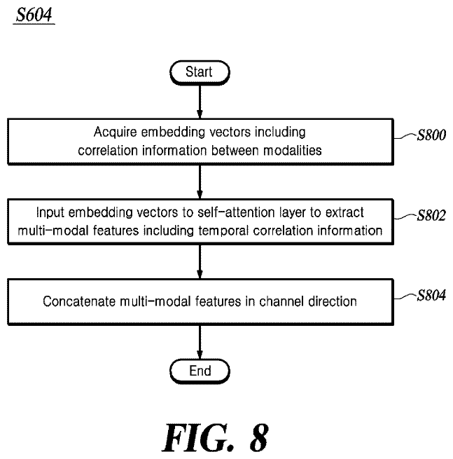

FIG. 8 is a flowchart illustrating a process of outputting a multi-modal emotion included in an emotion recognition method according to another embodiment of the present disclosure.

The emotion recognition apparatus 10 acquires embedding vectors including correlation information between modalities (S800). Here, a process of acquiring the embedding vectors (S800) includes a process of acquiring the first embedding vector including the correlation information between the audio stream and the text stream based on the weighted sum of the feature for the audio stream and the feature for the text stream, and a process of acquiring the second embedding vector including the correlation information between the text stream and the audio stream based on the weighted sum of the feature for the text stream and the feature for the audio stream.

The emotion recognition apparatus 10 inputs the embedding vectors to the self-attention layer, and extracts multi-modal features including temporal correlation information (S802).

The emotion recognition apparatus 10 concatenates the multi-modal features in the channel direction (S804).

In the flowchart, each process is described as being sequentially executed, but this is merely an illustrative explanation of the technical idea of some embodiments of the present disclosure. Since those skilled in the art to which an embodiment of the present disclosure pertains may change and execute the process described in the flowchart within the range not departing from the essential characteristics of the embodiment of the present disclosure, and one or more of each process may be applied in parallel with various modifications and variations, the flowchart is not limited to a time-series sequence.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Various implementations of the systems and techniques described herein can be realized by a programmable computer. Here, the computer includes a programmable processor, a data storage system (including volatile memory, nonvolatile memory, or any other type of storage system or a combination thereof), and at least one communication interface. For example, the programmable computer may be one of a server, network equipment, a set-top box, an embedded device, a computer expansion module, a personal computer, a laptop, a personal data assistant (PDA), a cloud computing system, or a mobile device.

Although exemplary embodiments of the present disclosure have been described for illustrative purposes, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

### EXPLANATIONS OF SYMBOLS

10: Emotion recognition apparatus
100: Audio buffer
110: STT Model
120: Emotion recognition model

### CROSS-REFERENCE TO RELATED APPLICATIONS

This application claims priority from Korean Patent Application No. 10-2022-0025988 filed on Feb. 28, 2022, the disclosures of which are incorporated by reference herein in their entirety.

1. An emotion recognition method using an audio stream performed by an emotion recognition apparatus, the emotion recognition method comprising:
receiving an audio signal having a preset unit length to generate the audio stream corresponding to the audio signal;
converting the audio stream into a text stream corresponding to the audio stream; and
inputting the audio stream and the converted text stream to a pre-trained emotion recognition model to output a multi-modal emotion corresponding to the audio signal.

2. The emotion recognition method of claim 1, wherein the generating includes concatenating an audio signal pre-stored in an audio buffer with the audio signal to generate the audio stream.

3. The emotion recognition method of claim 2, further comprising:
resetting the audio buffer when a length of the audio signal stored in the audio buffer exceeds a preset reference length.

4. The emotion recognition method of claim 1, wherein the outputting includes
a pre-feature extraction step of extracting a first feature from the audio stream and extracting a second feature from the text stream;
a uni-modal feature extraction step of extracting a first embedding vector from the first feature and extracting a second embedding vector from the second feature;
a multi-modal feature extraction step of correlating the first embedding vector with the second embedding vector to extract a first multi-modal feature and a second multi-modal feature; and
concatenating the first multi-modal feature with the second multi-modal feature in a channel direction.

5. The emotion recognition method of claim 4, wherein the uni-modal feature extraction step includes
inputting the first feature to a first convolutional layer to extract a third feature having a preset dimension;
inputting the third feature to a first self-attention layer to acquire a first embedding vector including correlation information between words in a sentence corresponding to the audio stream;
inputting the second feature to a second convolutional layer to extract a fourth feature having the dimension; and
inputting the fourth feature to a second self-attention layer to acquire a second embedding vector including correlation information between words in a sentence corresponding to the text stream.

6. The emotion recognition method of claim 4, wherein the multi-modal feature extraction step includes
inputting a query embedding vector generated based on the first embedding vector to a first cross-modal transformer and inputting a key embedding vector and a value embedding vector generated based on the second embedding vector to extract the first multi-modal feature; and
inputting a query embedding vector generated based on the second embedding vector to a second cross-modal transformer and inputting a key embedding vector and a value embedding vector generated based on the first embedding vector to extract the second multi-modal feature.

7. The emotion recognition method of claim 4, further comprising:
outputting an audio emotion corresponding to the audio stream based on the first embedding vector; and
outputting a text emotion corresponding to the text stream based on the second embedding vector.

8. The emotion recognition method of claim 4, wherein the pre-feature extraction step includes inputting the audio stream to a Problem-Agnostic Speech Encoder+ (PASE+) to extract the first feature.

9. The emotion recognition method of claim 1, wherein the outputting includes
acquiring embedding vectors including correlation information between modalities;
inputting each of the embedding vectors to a self-attention layer to extract multi-modal features including temporal correlation information; and
concatenating the multi-modal features in a channel direction.

10. The emotion recognition method of claim 9, wherein the acquiring of the embedding vectors includes
acquiring a first embedding vector including correlation information between the audio stream and the text stream, based on a weighted sum of a feature for the audio stream and a feature for the text stream; and
acquiring a second embedding vector including correlation information between the text stream and the audio stream, based on the weighted sum of the feature for the text stream and the feature for the audio stream.

11. An emotion recognition apparatus using an audio stream, the emotion recognition apparatus comprising:
an audio buffer configured to receive an audio signal with a preset unit length and generate the audio stream corresponding to the audio signal;
a speech-to-text (STT) model configured to convert the audio stream into a text stream corresponding to the audio stream; and
an emotion recognition model configured to receive the audio stream and the converted text stream and output a multi-modal emotion corresponding to the audio signal.

12. A computer program stored in one or more computer-readable recording media to cause each step included in the emotion recognition method according to claim 1 to be executed.
